(19) United States
(12) Patent Application Publication
(10) Pub. No.: US 2011/0140408 A1
(43) Pub. Date: Jun. 16, 2011

(54) METHOD OF PRINTING A LOTTERY TICKET WITH A SCRATCH-OFF LAYER DEFINING A MULTI-COLOR PATTERN

(76) Inventors: Lyle Scrymgeour, Oakbank (CA); Robert Anderson, San Antonio, TX (US); Gerald Cormier, Winnipeg (CA); Tyson Kaus, Winnipeg (CA)

(21) Appl. No.: 12/638,048

(22) Filed: Dec. 15, 2009

(51) Int. Cl. B42D 15/00

(52) U.S. Cl. 283/67

(57) ABSTRACT

A lottery ticket has game data printed on a substrate in a game data area either directly onto the substrate or onto a covering layer where the game data area is firstly covered by a scratch-off layer which contains a white pigment following which the scratch-off layer is covered by a plurality of layers of ink each of which contains pigment defining different colors for the different layers and which are different from the white pigment of the scratch-off layer so as to form a four color pattern. The scratch-off layer and the inks are sufficiently transparent to view the game data therethrough so that the removal of the scratch-off layer and the inks acts to mark the game data by showing it in a different color from the original view through the layers.

This invention relates to a method of printing a lottery ticket with a scratch-off layer defining a multi-color pattern.

### BACKGROUND OF THE INVENTION

In printing multi-color patterns typically a four color process is used four inks are used which are three secondary colors of cyan, magenta and yellow; plus black. These inks are semi-transparent or translucent. Where two such inks overlap on the paper due to sequential printing impressions, a primary color is perceived. For example, yellow (minus blue) overprinted by magenta (minus green) yields red. Where all three inks may overlap, almost all incident light is absorbed or subtracted, yielding near black. It is because of this poor “subtractive” black that a separate black ink is used.

Two graphic techniques are required to prepare images for four-color printing. In the “pre-press” stage, original images are translated into forms that can be used on a printing press, through “color separation,” and “screening” or “half-toning.” Application of the inks can be carried out by conventional printing plates or by variable imaging techniques well known to persons skilled in this art.

These techniques have been applied in the manufacture of lottery tickets with four color patterns printed onto the ticket either at the area of the game data or in other areas or both.

One form of lottery ticket requires that the player be able to enter visual marks on the ticket by removing a scratch-off layer so that the underlying material is visible, with the ticket having a different color appearance with the scratch-off layer in place from that with the scratch-off layer removed. This technique is typically used in bingo-type games but can also be used in other games where the ticket needs to be “marked”.

U.S. Pat. No. 5,193,815 (Pollard) issued Mar. 16, 1993 to Pollard Banknote discloses a game card to be marked such as a bingo card for playing at an instant bingo game which includes four separate bingo playing areas each of which is in the form of a bingo card with the numbers printed thereon in conventional manner. On top of each of the second playing areas is applied a translucent coat of a scratchable material which is pigmented so as to modify the appearance of the underlying color of the area. The playing area can therefore be marked in relation to those numbers appearing on the first area simply by scratching away the translucent layer to provide a visual distinction. The game card is simple and effective and requires printing of the playing numbers only once as they can be viewed through the translucent layer.

U.S. Pat. No. 6,076,860 (Holman) issued Jun. 20, 2000 to Oberthur Gaming Technologies and now assigned to Scientific Games discloses a similar scratch-off lottery game including a substrate having at least one area having printed indicia thereon. In this case, instead of the covering material forming a translucent pigmented coat of a scratchable material, the printed indicia are covered by a clear transparent layer which can be removed by scratching, and a layer on top of the clear transparent layer which is colored, transparent and made of a non-scratch-off material.

### SUMMARY OF THE INVENTION

It is one object of the invention to provide an improved lottery ticket of this general type.

According to one aspect of the invention there is provided a method of printing a lottery ticket comprising:

providing a substrate;

printing game data in a game data area either directly onto the substrate or onto a covering layer over the substrate;

covering the game data area with a scratch-off layer which contains a pigment providing a color;

covering the scratch-off layer with a plurality of layers of ink each of which contains pigment defining different colors for the different layers and which are different from the color of the scratch-off layer;

the scratch-off layer and the inks being sufficiently transparent to view the game data therethrough;

and printing a multi-color pattern over the game data area by selecting the colors of the pigments such that all of the colors contribute to the colors of the pattern.

White is the preferred color for the scratch-off layer because of its reflective properties. White provides the optimal base on which to print overlaying colors. White reflects back all colors while avoiding absorbing some of the color. This achieves the best color reproduction.

By contrast, the worst color would be black because it does not reflect well and would further interfere with the legibility of the letters and numbers below, which must remain legible in order for the player to be able to play the game properly.

Other colors could be used. For example a yellow, however this selection would impact on the color of the overlying layers as viewed by the eye. Even if a light yellow is selected, a magenta layer printed above would tend to turn orange. When using a color other than white, at the separation stage, where the colors for the pattern are selected, some color correction can be done which would help to reduce the impact.

A further benefit of applying a white or an alternate color layer, different from clear material, is that it enables to the press operators, during setup, to visually determine whether the scratch-off layer is being located in correct position on the ticket and to then monitor the registration of multiple elements of the printed layers including the lily pad, variable data and scratch-off throughout the run. An area formed instead by a clear material, by contrast, is difficult to see and can result in misregistration of the critical elements.

For example in the above Holman patent there is risk that the clear scratch-off layer is not located in the proper position and when the non-scratchable overprint colors are applied they are not applied over the scratch-off layer and hence are not removable. This fault causes the player high levels of frustration because they cannot properly play to the game to mark and identify easily where they have matched a letter or number.

Another advantage of the method herein is that the use of scratchable overprinting colors allows the player to still play the game properly even if the white or alternate scratch-off layer has been misprinted or is not present on the ticket. If the scratch-off layer is missing the combined colors of the overprinting layer will change from those intended but the ticket remains playable.

Another advantage of this construction is that the color in the scratch-off layer co-operates with the colors in the printed inks to provide the finished pattern thus reducing costs and providing increased alternatives for the pattern thus obtaining a synergistic effect.

Preferably the game data is printed onto a white lily pad applied onto the substrate.

Preferably the colors of the pigments are selected to provide a four color printing system.

Preferably the method includes visually determining whether the scratch-off layer is located in correct position on the ticket during printing by observing the pigment in the scratch-off layer.

According to a second aspect of the invention there is provided a method of printing a lottery ticket comprising:

providing a substrate;

printing game data in a game data area either directly onto the substrate or onto a covering layer over the substrate;

covering the game data area with a scratch-off layer which contains a white pigment;

covering the scratch-off layer with a plurality of layers of ink each of which contains pigment defining different colors for the different layers and which are different from the white pigment of the scratch-off layer;

the scratch-off layer and the inks being sufficiently transparent to view the game data therethrough.

Preferably the game data is printed in an ink which is pigmented such that it is visible on the white lily pad and such that the white scratch-off layer applied over the game data changes the appearance of the game data sufficiently to be immediately visually apparent when the scratch-off layer is removed. Preferably the game data is printed in black ink.

Thus the key point of this application relates to the game area covered by a multi-colored overprint design through which the data to match can be seen.

It will be appreciated that this concept may include a series of such game areas on a single ticket which changes color to indicate that the number has been matched and scratched. Also typically each ticket will include a data matching element where the numbers to be matched are set out generally covered by a player removable opaque covering such as a scratch-off layer. However this is not essential and a number of other game formats are possible.

In practice it is possible to provide only the one game data area covered by translucent scratch-off. Such tickets are played in conjunction with externally supplied numbers, letters or symbols to match. For example the player can buy a bingo card with the translucent covering only and can watch a TV show at a prescribed time to determine what the matching numbers are. Play can be a normal Bingo and if there is a winner the player presents their card to a lottery retailer for validation.

Alternatively, the ticket can be given out for free and the player is required to visit a store each week to obtain the numbers to match through a poster or by collecting another card with the numbers printed on it.

### BRIEF DESCRIPTION OF THE DRAWINGS

One embodiment of the invention will now be described in conjunction with the accompanying drawings in which:

FIG. 1 is a schematic cross sectional view through a ticket manufactured according to the present invention.

FIG. 2 is a schematic illustration of a method of ticket manufacture according to the present invention.

In the drawings like characters of reference indicate corresponding parts in the different figures.

### DETAILED DESCRIPTION

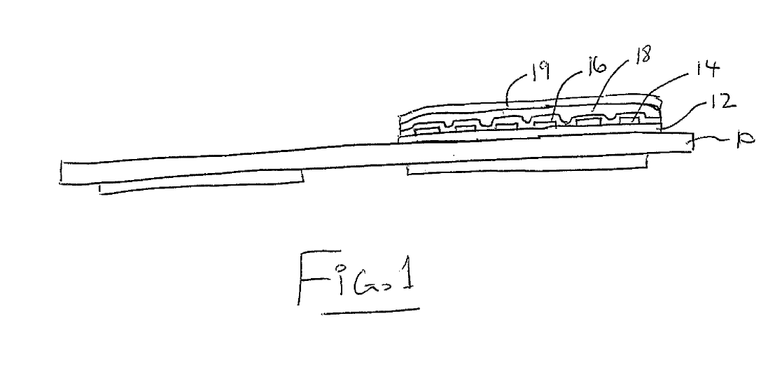

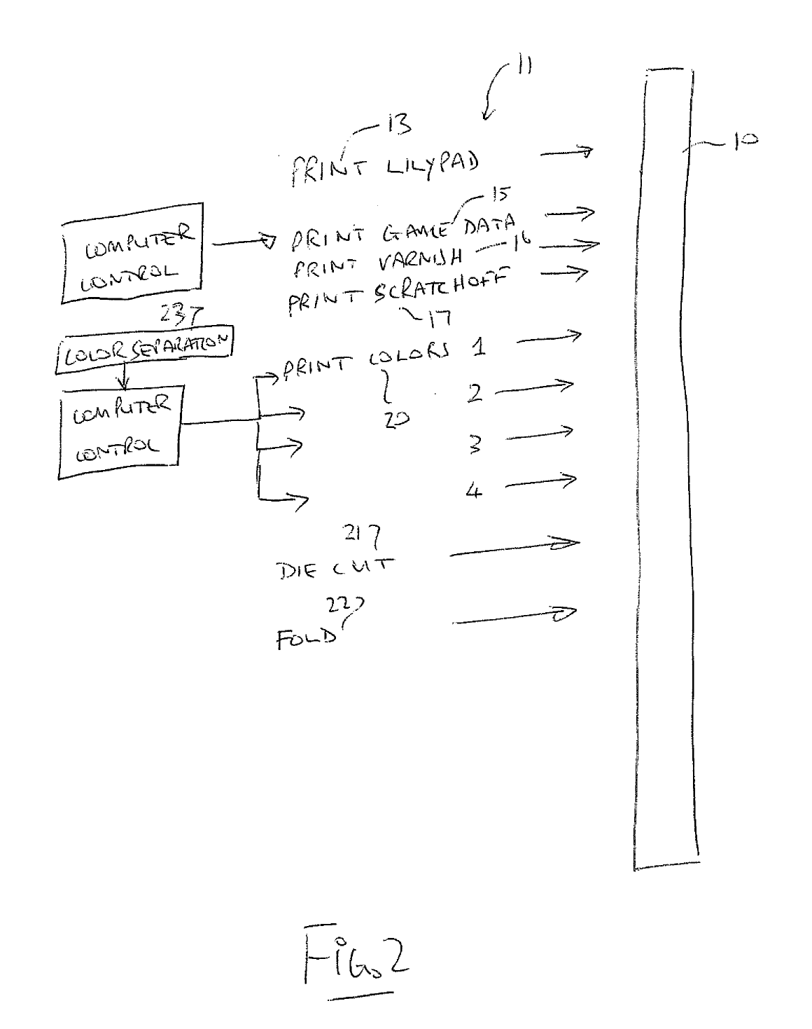

In FIG. 2 is shown the method for manufacturing the ticket of FIG. 1. This provides a method in which a substrate strip 10 is supplied and passed through a printing line 11. The printing line is arranged to print a number of separate layers as follows:

a) A white lily pad 12 is printed at a first step 13 to define a secure area on the card for the game to be applied.

b) Game data 14 is printed at a second step 15 by variable image printing using known techniques in the game data area onto the lily pad defining a covering layer over the substrate.

c) Typically a varnish or other fixing layers are applied at 16 over the game data to ensure that it is not removed in scratching.

d) A scratch-off layer 18 is printed at a step 17. The scratch-off layer contains the pigment providing a color.

e) The scratch-off layer 18 is covered with a plurality of layers shown at 19 printed in a step 20 of ink each of which contains pigment defining different colors for the different layers and which are different from the color of the scratch-off layer.

The layers 19 provide a multi-color pattern over the game data area by selecting the colors of the pigments using the computer control 21 such that all of the colors contribute to the colors of the pattern.

The colors of the pigments in the multi-color layer 19 are selected to provide a four color printing system.

The scratch-off layer 18 and the inks of the layer 19 are sufficiently transparent to view the game data therethrough.

In playing the game, the player removes the layers 18 and 19 in those areas what the player wishes to mark in that the lily pad and game data when viewed directly with the layers 18 and 19 removed appears visually distinct from the lily pad and game data when viewed through those layers.

During printing the operator acts to visually determine whether the scratch-off layer is located in correct position on the ticket during printing by observing the pigment in the scratch-off layer as it is applied over the lily pad.

The method used for the overprinting of the scratch-off material 18 uses process printing which is based on the application of colored inks, either Cyan/Magenta/Yellow (three color Process) or with the addition of Black (four color Process). Process inks allow for viewing of the underlying layers through the top colored layer and these colors combine visually to create a broad range of colors to be seen within a printed image. For example where the yellow color overlays the color seen is green.

While process inks can be run in solid form, which creates a limited number of additional colors, typically the images being printed are screened or separated at step 23 to different intensities to create a broader range of colors. The most common screen method would be “half tones”, a method that results in dots of varying size being printed across the image. Once an original image is prepared, the various colors in the photograph, artwork, design, etc. are separated into either the three base colors (CYM) or 4 base colors (CYMK). Separation can be done in various ways but is primarily electronically. Once the image is separated, if the image is to be printed on a printing press, printing plates are prepared for each of the base colors to be printed.

The three or four printing plates each contain the dots, in varying sizes, including solids, required to reproduce the colored image as was created during the separation process. Additional colors can be added for special effects. In addition to the images to be applied over the translucent scratch-off layer, the same plates may contain the dots patterns required to print the other graphic elements in the overall ticket design.

Thus during the printing process, which could be offset, flexo, gravure, etc. or a combination thereof, the substrate is printed with various layers designed to produce a secure ticket. Typically layers, which are applied prior to the application of the scratch-off and graphic images would include lily pad(s), digital imaging, seal-coat(s) and protective varnish.

Once the varnish is applied over the Player's area, the next layer is a translucent scratch-off. This scratch-off contains pigments which provide color to the layer but at a level which allows the underlying digital data to remain visible. Typically this layer will be white but other colors can be used. If an alternative color is being used the overprinting colors have to adjusted in the separation process 23 to accommodate the change. For example if a light yellow is used color values have to be adjusted.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A method of printing a lottery ticket comprising:
providing a substrate;
printing game data in a game data area either directly onto the substrate or onto a covering layer over the substrate;
covering the game data area with a scratch-off layer which contains a pigment providing a color;
covering the scratch-off layer with a plurality of layers of ink each of which contains pigment defining different colors for the different layers and which are different from the color of the scratch-off layer;
the scratch-off layer and the inks being sufficiently transparent to view the game data therethrough;
and printing a multi-color pattern over the game data area by selecting the colors of the pigments such that all of the colors contribute to the colors of the pattern.

2. The method according to claim 1 wherein the game data is printed onto a white lily pad applied onto the substrate.

3. The method according to claim 1 wherein the colors of the pigments are selected to provide a four color printing system.

4. The method according to claim 1 including visually determining whether the scratch-off layer is located in correct position on the ticket during printing by observing the pigment in the scratch-off layer.

5. A method of printing a lottery ticket comprising:
providing a substrate;
printing game data in a game data area either directly onto the substrate or onto a covering layer over the substrate;
covering the game data area with a scratch-off layer which contains a white pigment;
covering the scratch-off layer with a plurality of layers of ink each of which contains pigment defining different colors for the different layers and which are different from the white pigment of the scratch-off layer;
the scratch-off layer and the inks being sufficiently transparent to view the game data therethrough.

6. The method according to claim 5 wherein the game data is printed onto a white lily pad applied onto the substrate.

7. The method according to claim 6 wherein the game data is printed in an ink which is pigmented such that it is visible on the white lily pad and such that the white scratch-off layer applied over the game data changes the appearance of the game data sufficiently to be immediately visually apparent when the scratch-off layer is removed.

8. The method according to claim 6 wherein the game data is printed in black ink.

9. The method according to claim 5 wherein the colors of the pigments are selected to provide a four color printing system.

10. The method according to claim 5 including visually determining whether the scratch-off layer is located in correct position on the ticket during printing by observing the pigment in the scratch-off layer.

11. A method of printing a lottery ticket comprising:
providing a substrate;
printing game data in a game data area either directly onto the substrate or onto a covering layer over the substrate;
covering the game data area with a scratch-off layer which contains a white pigment;
covering the scratch-off layer with a single layer of ink containing colored pigment different in color from the white pigment of the scratch-off layer;
the scratch-off layer and the ink being sufficiently transparent to view the game data therethrough.

12. The method according to claim 11 wherein the game data is printed onto a white lily pad applied onto the substrate.

13. The method according to claim 12 wherein the game data is printed in an ink which is pigmented such that it is visible on the white lily pad and such that the white scratch-off layer applied over the game data changes the appearance of the game data sufficiently to be immediately visually apparent when the scratch-off layer is removed.

14. The method according to claim 12 wherein the game data is printed in black ink.

15. The method according to claim 11 including visually determining whether the scratch-off layer is located in correct position on the ticket during printing by observing the pigment in the scratch-off layer.
